(19) United States
(12) Patent Application Publication
(10) Pub. No.: US 2006/0199019 A1
(43) Pub. Date: Sep. 7, 2006

(54) Adhesive sheet for brazing magnesium alloy and method for brazing magnesium and aluminum alloy

(76) Inventors: Seung Taig Oh, Chonan-city (KR); Beom Joo Kim, Suwon-city (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/356,847

(22) Filed: Feb. 17, 2006

(30) Foreign Application Priority Data
Mar. 2, 2005 (KR) 10-2005-17320

(51) Int. Cl. B32B 13/04

(52) U.S. Cl. 428/446

(57) ABSTRACT

An adhesive sheet for binding basic materials including an adhesive material layer with binding layer laminated on both sides, with the binding layer having a thickness of 6 to 20% of the thickness of the adhesive material layer. The binding layer contains a mixture of 20 to 70 weight % of a binder and 30 to 80 weight % of a mixed powder, where the mixed powder includes 60 to 66 weight % of flux powder, 30 to 33 weight % of aluminum and silicon alloy powder, and 1 to 10 weight % of cesium powder or lithium powder. The adhesive material layer is a mixture of 86 to 94 weight % of aluminum and 6 to 14 weight % of silicon. A brazing method for binding basic materials composed of aluminum alloy containing 0.2˜2.5% of magnesium in aluminum prepares an adhesive sheet as described, binds the adhesive sheet at a binding point between the basic materials, and brazes the basic material to which the adhesive sheet is bound.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates brazing magnesium and aluminum alloy, and more particularly to assembling components of a device by such brazing.

### BACKGROUND OF THE INVENTION AND TECHNICAL PROBLEMS POSED BY THE PRIOR ART

Heat exchangers are usually manufactured by binding components of aluminum alloy material that have good heat conduction rate, with the heat exchanger bound through brazing after each component is assembled. There are two types of brazing methods: vacuum brazing, and Nocolok brazing (in which products are continuously brazed in a nitrogen environment). In general, the Nocolok brazing method has better productivity compared to the vacuum brazing method, and therefore is now used extensively in production.

The flux used in such production usually consists of potassium tetrafluoroaluminate (KAlF₄) and melts in 565˜572° C. to braze and bind the aluminum. The melted flux reacts with and dissolves the oxide layer that exists on the surface of the aluminum to remove the oxidation membrane, and prevents re-oxidation by covering the dissolved aluminum surface.

Moreover, like most heat exchangers, aluminum heat exchangers usually require components with high strength. As a result, magnesium (Mg) has been included in order to improve the strength of such components. When the magnesium content is increased in the aluminum material, a solid solution is formed because the solute atoms (Mg) enter in the lattice of the solvent atoms (Al), and thus the lattice becomes twisted and a stress field is formed near the solute atoms. The stress field caused by the solute atoms interacts with the stress field of the operational electric potential and prevents the movement of electric potential, thus a solid solution is formed which results in the strengthening of the material. Due to this phenomenon of strengthening, as a result of the formation of a solid solution, the solidity of the basic structure is strengthened.

Notwithstanding the above, increased magnesium content in the aluminum material has an adverse effect on brazing, because magnesium decreases the moisture content of the basic materials during Nocolok brazing, in which flux containing KAlF₄ is used. Also, the magnesium present in the basic materials reacts with the flux to form KMgF₃ which has a melting point of 1070° C. and MgF₂ which has a melting point of 1270° C. and lowers the flux function as well as the adhesive function between the bonded materials. Therefore, for the components of the heat exchanger, the magnesium content is generally set to below 0.2%, and for components requiring regular adhesive strength, the magnesium content is set within 0.45%. Aluminum material that contains magnesium in an amount greater than 0.45% or 0.2%, which could provide increased material strength, cannot be used at the present time because of poor binding during brazing.

As a result of the above, the ability to improve the strength of heat exchanger components has heretofore been limited, with the service live of heat exchangers thereby similarly limited. This problem is particularly acute in systems where CO₂ is used as the refrigerant, where greater component strength and durability is particularly important.

The present invention is directed toward overcoming one or more of the problems set forth above.

### SUMMARY OF THE INVENTION

In one aspect of the present invention, an adhesive sheet for binding basic materials is provided, including an adhesive material layer, and a binding layer laminated on both sides of the adhesive material layer. The binding layer contains a mixture of binder and a mixed powder, where the mixed powder includes 60 to 66 weight % of flux powder, 30 to 33 weight % of aluminum and silicon alloy powder, and 1 to 10 weight % of cesium powder or lithium powder.

In one form of this aspect of the present invention, the binding layer is a mixture of 20 to 70 weight % of the binder and 30 to 80 weight % of the mixed powder. In a further form, the binding layer has a thickness of 6 to 20% of the thickness of the adhesive material layer.

In another form of this aspect of the present invention, the adhesive material layer is a mixture of 86 to 94 weight % of aluminum and 6 to 14 weight % of silicon.

In still another form of this aspect of the present invention, the binding layer has a thickness of 6 to 20% of the thickness of the adhesive material layer.

In another aspect of the present invention, a brazing method is provided for binding basic materials composed of aluminum alloy containing 0.2˜2.5% of magnesium in aluminum. The method includes the steps of (a) preparing an adhesive sheet, (b) binding the adhesive sheet at a binding point between the basic materials, and (c) brazing the basic material to which the adhesive sheet is bound. The adhesive sheet is prepared with an adhesive material layer without a high concentration of magnesium content, and a binding layer spread on both sides of the adhesive material layer.

In one form of this aspect of the present invention, the preparing step prepares the adhesive sheet with an adhesive material layer, and a binding layer laminated on both sides of the adhesive material layer, where the binding layer contains a mixture of binder and a mixed powder, where the mixed powder includes 60 to 66 weight % of flux powder, 30 to 33 weight % of aluminum and silicon alloy powder, and 1 to 10 weight % of cesium powder or lithium powder. In a further form, the preparing step forms the binding layer with a mixture of 20 to 70 weight % of the binder and 30 to 80 weight % of the mixed powder.

### BRIEF DESCRIPTION OF THE DRAWINGS

FIG. 1 is an exploded view of the composition of the adhesive sheet for brazing magnesium alloy in accordance with the present invention;

FIG. 2 illustrates an adhesive sheet bound between magnesium alloys in accordance with the present invention; and

FIG. 3 is a flow chart of the sequence of the brazing method of magnesium and aluminum alloy in accordance with the present invention.

### DETAILED DESCRIPTION OF THE INVENTION

In accordance with the present invention, as described in detail hereafter, an adhesive sheet is provided which that can easily bind materials with high magnesium content, and a related brazing method is described which can increase brazing efficiency by preventing mixing together of magnesium from two different materials.

Specifically, an adhesive sheet may be used which is composed of an adhesive material layer that prevents the diffusion of magnesium, mixed powder including flux powder and metal powder, and binding layers composed of binders that laminate to both sides of the adhesive material layer. The binding layer is composed by mixing 20 to 70 weight % binder and 30 to 80 weight % mixed powder.

The metal powder may advantageously be composed of aluminum and silicon alloy powder, cesium powder or lithium powder.

The mixed powder may advantageously be composed of 60 to 66 weight % flux powder, 30 to 33 weight % aluminum and silicon alloy powder, 1 to 10 weight % of cesium powder.

The adhesive material layer desirably may be produced by mixing 86 to 94 weight % aluminum and 6 to 14 weight % silicon.

The thickness of the binding layer may desirably be 6 to 20% of the thickness of the adhesive material layer.

The method of brazing magnesium and aluminum alloy according to the present invention has several steps, including a step in which an adhesive sheet is prepared by spreading binding layers to both sides of the adhesive material layer that binds the above-mentioned basic materials and prevents magnesium from becoming highly concentrated, a step in which the above-mentioned adhesive sheet forms a bond at an adhesive point between the basic materials that are composed of an aluminum alloy containing 0.2˜2.5% magnesium, and a step in which the adhesive sheet brazes the basic materials that are bound together.

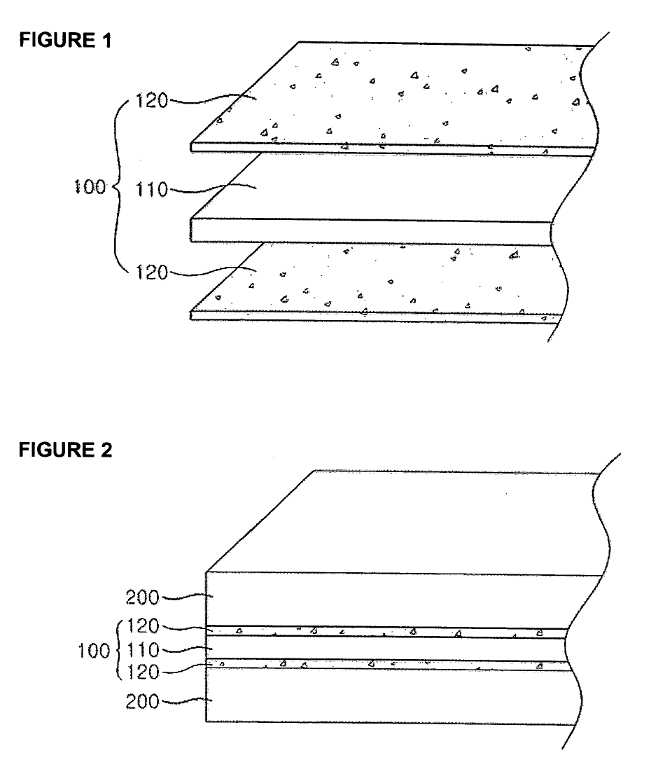

A practical example of the adhesive sheet for brazing magnesium alloy, and method of brazing magnesium and aluminum alloy, in accordance with the present invention, is as described below based on the attached figures (where FIG. 1 is an exploded view of the composition of the adhesive sheet for brazing magnesium alloy and FIG. 2 shows the adhesive sheet bound between the magnesium and aluminum alloy under this invention.

Specifically, as shown in the FIG. 1, the adhesive sheet (100) for brazing magnesium and aluminum alloy under this invention is composed of the adhesive material layer (110) that prevents diffusion of the magnesium content in the binding layer (120) at both sides of the adhesive material layer (110).

The adhesive sheet (100) is bound between two magnesium and aluminum alloys (200) as shown in the FIG. 2.

In accordance with the present invention, the thickness of the binding layer (120) may advantageously be 6 to 20% of the thickness of the adhesive material layer (110), because if the binding layer (120) is excessively thin, binding will not be perfect, and if the binding layer (120) is excessively thick, there will be material loss.

It should be appreciated that an adhesive sheet (100) such as disclosed can be advantageously used in many applications, such as binding various tubes or fins that make up a heat exchanger, and in binding magnesium and aluminum alloy through a brazing process.

As previously noted, the adhesive material layer (110) may advantageously be manufactured within the scope of the present invention with components that contain absolutely no magnesium in order to prevent decrease of binding capacity due to magnesium, and by mixing 86 to 94 weight % of aluminum and 6 to 14 weight % of silicon for heat conductivity. It is desirable to manufacture the adhesive material layer (110) with material A4045 that consists of 92 to 89 weight % of aluminum and 8 to 11 weight % of silicon, or material A4047 that consists of 86 to 88 weight % of aluminum and 12 to 14 weight % of silicon.

As also previously noted, the binding layer (120) may advantageously be manufactured within the scope of the present invention by dissolving 30 to 80 weight % of mixed powder in 20 to 70 weight % of binder.

The mixed powder is composed of flux powder that serves for dissolving binder, aluminum powder for the heat conductivity, and silicon powder for improving the adhesion.

The mixed powder can also be composed of cesium powder or lithium powder. If cesium powder or lithium powder is included in the mixed powder, magnesium reacts with cesium or lithium before reacting with the flux and thereby inhibits the formation of the high-melting compounds, KMgF₃ and MgF₂. If the formation of KMgF₃ and MgF₂ is inhibited, the fluidity of the binding layer (120) improves, and thus it can be supplied smoothly to the surface or binding area. As a result, a better brazing capability can be achieved.

If the silicon content is too low, the adhesion decreases, and if the silicon content is excessive, damage to the magnesium and aluminum alloy (200) occurs. If the cesium content is excessive, both flux function and adhesion efficiency decrease. Therefore, it is desirable to have the mixed powder composed of 60 to 66 weight % of flux powder, 30 to 33 weight % of aluminum and silicon alloy powder, and 1 to 10 weight % of cesium powder or lithium powder.

The practical example shown in FIG. 2 uses magnesium and aluminum alloy (200) as the basic material, and brazed two different magnesium and aluminum alloys (200) using the adhesive sheet (100).

If the brazing of the adhesive sheet (100) between the magnesium and aluminum alloy (200) is complete, the adhesive sheet (100) is used as a medium through the brazing process to bind two different magnesium and aluminum alloys (200). The melting point of magnesium and aluminum alloy (200) is approximately above 660° C., and the melting point of the adhesive material layer is 585˜620° C. Therefore, if external heat is applied, the adhesive material layer (110) will melt before the magnesium and aluminum alloy (200) does, so the former will bind two different magnesium and aluminum alloys (200).

Since the two different magnesium and aluminum alloys (200) bind to each binding layer (120) that is spread on both sides of the adhesive material layer (110), they do not directly contact each other. Also, because the adhesive material layer (110) is composed of an aluminum and silicon mixture that does not contain magnesium, the magnesium contained in the magnesium and aluminum alloy (200) is completely cut off by the adhesive material layer (110).

Therefore, using the adhesive sheet (100) of this invention can easily and firmly bind alloys that have high magnesium content, through a brazing process.

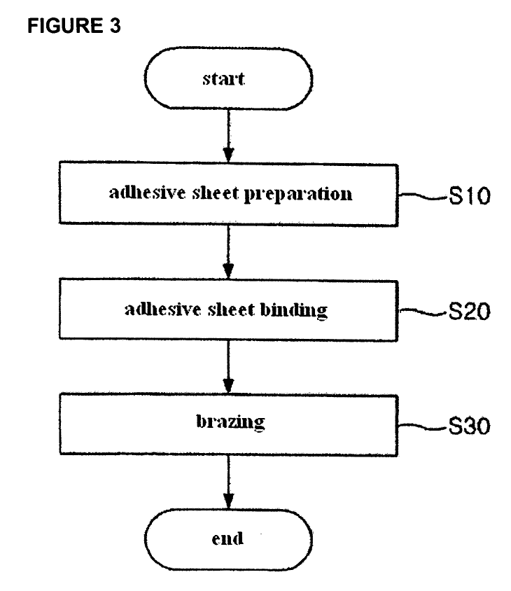

FIG. 3 illustrates the sequence of the brazing of magnesium aluminum alloy according to the present invention.

The first step (S10) prepares an adhesive sheet (100) by spreading binding layers (120) on both sides of the adhesive material layer (110) that binds the above-mentioned basic materials (200) and prevents magnesium from becoming highly concentrated.

A second step (S20) binds the above-mentioned prepared adhesive sheet (100) at an adhesive point between the basic materials (200) that are composed of an aluminum alloy containing 0.2˜2.5% magnesium.

In the third step (S30), the basic materials (200) are bound by brazing.

The two magnesium and aluminum alloys (200) bound by brazing with the adhesive sheet (100) in-between prevent the phenomenon of a decrease in adhesion because the mixing of magnesium content is prevented by the adhesive material layer (110). Moreover, because the method for brazing magnesium and aluminum alloy is composed of separate steps of preparing the adhesive sheet and the brazing, manufacturing of the adhesive sheet and brazing process can be performed separately.

It should thus be appreciated that the present invention enables the use of alloys having higher magnesium content to strengthen the material without thereby also sacrificing bonding strength of the brazing. Moreover, using the brazing method of this invention has the advantage of easily and firmly binding materials with high magnesium content through the brazing process.

It should also be appreciated that this invention was explained above in detail using a preferred practical example. However, the invention is not limited to the specific practical example. It should rather be interpreted based on the extent of the attached claims. Moreover, anyone who has acquired common knowledge in the related field of technology, should understand that various modifications and alterations are possible without deviating from the scope of this invention. Further, still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. An adhesive sheet for binding basic materials, comprising:
an adhesive material layer; and
a binding layer laminated on both sides of said adhesive material layer, said binding layer containing a mixture of binder and a mixed powder, where said mixed powder includes 60 to 66 weight % of flux powder, 30 to 33 weight % of aluminum and silicon alloy powder, and 1 to 10 weight % of cesium powder or lithium powder.

2. The adhesive sheet of claim 1, wherein said binding layer is a mixture of 20 to 70 weight % of said binder and 30 to 80 weight % of said mixed powder.

3. The adhesive sheet of claim 2, wherein said binding layer has a thickness of 6 to 20% of the thickness of said adhesive material layer.

4. The adhesive sheet of claim 1, wherein said adhesive material layer is a mixture of 86 to 94 weight % of aluminum and 6 to 14 weight % of silicon.

5. The adhesive sheet of claim 1, wherein said binding layer has a thickness of 6 to 20% of the thickness of said adhesive material layer.

6. A brazing method for binding basic materials composed of aluminum alloy containing 0.2˜2.5% of magnesium in aluminum, comprising the steps of:
preparing an adhesive sheet with
an adhesive material layer without a high concentration of magnesium content, and
a binding layer spread on both sides of the adhesive material layer;
binding said adhesive sheet at a binding point between said basic materials; and
brazing the basic material to which the adhesive sheet is bound.

7. The method of claim 6, wherein said preparing step prepares the adhesive sheet of claim 1.

8. The method of claim 6, wherein said preparing step prepares the adhesive sheet of claim 2.
